(19) United States
(12) Patent Application Publication
(10) Pub. No.: US 2009/0189727 A1
(43) Pub. Date: Jul. 30, 2009

(54) Inductor device

(75) Inventor: Ding-Houng Wang, Taipei City (TW)

Correspondence Address: CKC & Partners Co. Ltd;12th Fl., Ruttonjee House, 11 Duddell Street, Hong Kong, HK

(73) Assignee: Inventec Corporation

(21) Appl. No.: 12/010,724

(22) Filed: Jan. 29, 2008

(51) Int. Cl. H01F 5/00; H01F 41/04; H01F 41/00

(52) U.S. Cl. 336/200; 29/606

(57) ABSTRACT

An inductor device includes at least one printed circuit board, a magnetic device and a metal wire. The printed circuit board has through holes disposed on it. The magnetic device passes through the through holes on the printed circuit board. The metal wire surrounds the magnetic device with an eddy shape.

### BACKGROUND

1. Field of Invention

The present invention relates to an inductor device and the manufacturing method thereof.

2. Description of Related Art

Generally speaking, inductors have a coil wrapped around an iron core. In the conventional integrated circuit, the iron core is placed on the surface of the printed circuit board, and the coil surrounds the iron core. Because the iron core and the coil use a lot of space, the whole integrated circuit requires a larger space as a result.

Therefore, there is a need for a new inductor device which requires smaller space and the whole integrated circuit space can also be reduced.

### SUMMARY

According to one embodiment of the present invention, an inductor device includes at least two printed circuit boards, a magnetic device, and a metal wire. At least two through holes are disposed on each of the printed circuit boards. The magnetic device passes through the through holes disposed on the printed circuit board. The metal wire surrounds the magnetic device with an eddy shape.

According to another embodiment of the present invention, the method for manufacturing the inductor device, includes estimating the required inductance, estimating a required turns of a coil according to the inductance, the area and the length of a magnetic device, disposing the coil with the required turns on at least one of the printed circuit board, drilling at least one hole on the printed circuit board, in which the hole is disposed inside the coil, and passing the first U-shaped iron and the second U-shaped iron through the through hole disposed on the printed circuit board.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows the cross-section of the inductor device according to one embodiment of the present invention; and

FIG. 2 shows the flow chart of the method for manufacturing the inductor device according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The inductor device and the manufacturing method thereof pass the magnetic device through the printed circuit board, and then dispose the coil on the printed circuit board or between the printed circuit boards to generate the inductor device.

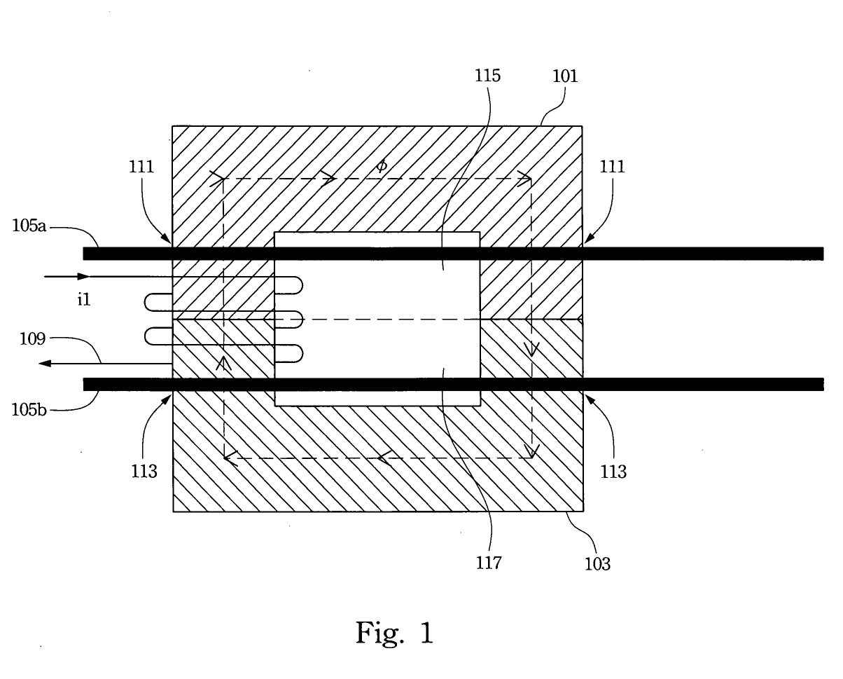

FIG. 1 shows the cross-section of the inductor device according to one embodiment of the present invention. The inductor device includes the printed circuit board (PCB) 105a, the printed circuit board 105b, the metal wire 109 and the magnetic devices. The printed circuit board 105a and printed circuit board 105b have through holes 111 and through holes 113 disposed on them respectively. The magnetic devices, such as the first U-shaped iron core 101 and the second U-shaped iron core 103, have a first cavity 115 and a second cavity 117 respectively. The first U-shaped iron core 101 passes through the through holes 111 with its first cavity 115 facing the printed circuit board 105a. The second U-shaped iron core 103 passes through the through holes 113 with its second cavity 117 facing the printed circuit board 105b.

The coil, such as the metal wire 109, made of copper, surrounds the first U-shaped iron core 101 and the second U-shaped iron core 103 with an eddy shape. The metal wire 109 with required turns can be disposed on the surface of the printed circuit board 105a\105b by the PCB layout process or by hand. Because the metal wire 109 can be set on the surface of the printed circuit board 105a\105b by PCB layout process, additional wiring space beyond the printed circuit board 105a\105b for the metal wire to surround the inductor device is no longer required, which reduces the whole circuit volume; in addition, the step to wire by hand is eliminated, which simplifies the overall manufacturing process.

When the current flows through the metal wire 109, magnetic flux φ is generated along with the first U-shaped iron core 101 and the second U-shaped iron core 103. Assume that the magnetic flux density B is uniform, and the magnetic flux density B is vertical to the cross-section of the U-shaped iron core 101\103, the magnetic flux φ is equal to BA as a result, in which A is the cross-sectional area of the U-shaped iron core 101\103. In addition, because B=μH, therefore the total magnetic flux φ is equal to

$$φ = \frac{uNi}{l} A ,$$

in which H presents the magnetic field intensity

$$( H = \frac{Ni}{l} ) ,$$

l represents the average length of the magnetic flux φ, N represents the turns of the coil 109, and μ represents the permeability which varies from material to material. Further, because the inductance L is equal to

$$N \frac{d φ}{d t}$$

(i is the current volume), hence the inductance L of the inductor device shown in FIG. 1 is equal to

$$\frac{{uN}^{2} A}{l} .$$

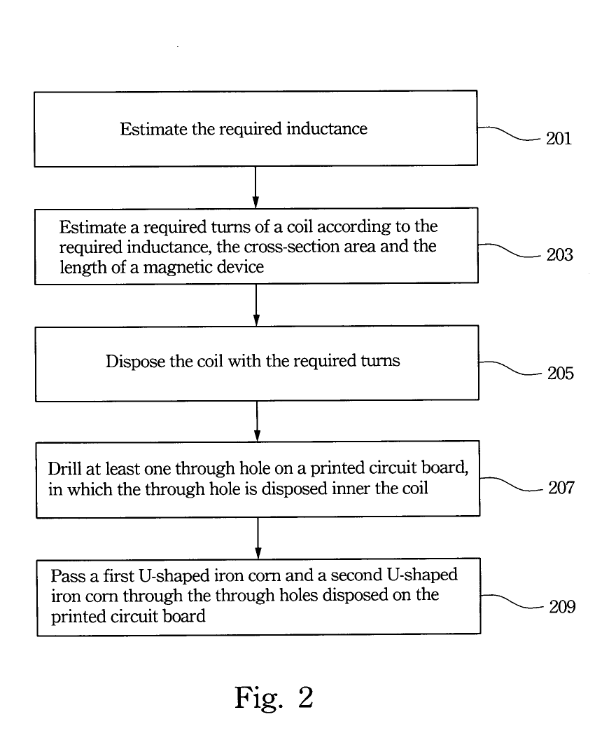

FIG. 2 shows the flow chart of the method for manufacturing the inductor device according to one embodiment of the present invention. The required inductance is estimated in the step 201, and the required turns of the coil is also estimated according to the inductance, the cross-sectional area and the length of the magnetic device in step 203. The inductance L is equal to

$$L = \frac{{uN}^{2} A}{l} ,$$

in which A represents the cross-section area of the iron core used to generate the magnetic flux φ, l represents the average path length of the magnetic flux φ (the length of the U-shaped iron core, too), N represents the turns of the coil, and μ represents the permeability. For example, if the required inductance is 1.5 uH, and the permeability μ is 2.89*10⁻³ (vacuum permeability 4π×10⁻⁷ multiply comparative permeability 2300), the average path length of the magnetic flux φ is 0.032 m, and the cross-sectional area of the U-shaped iron core is 2.42 cm², then the derived turns of the coil is about 6.45.

In the actual manufacturing process of the inductor device, the nearest integer 7 is selected for the coil turns. In order to prevent magnetic saturation, the 0.005 m wide air gap is added to the inductor device, hence the total reluctance is 33034392.16, and the actual measured inductance is 1.48 uH which is roughly equal to the required inductance.

After the turns of the coil have been derived, the coil with the derived turns is disposed on the printed circuit board (step 205), in which the coil is made of metal, such as copper. The coil may be placed on the printed circuit board by the PCB layout procedures, or wired between the printed circuit boards by human hands.

After the coil has been disposed on/between the printed circuit boards, the through holes are placed inside the coil by drilling (step 207), the first U-shaped iron core and the second U-shaped iron core are passed through the through holes on the printed circuit board (step 209). The first U-shaped iron core and the second U-shaped core have first cavity and the second cavity respectively. These two iron core pass the through holes on the printed circuit board with their cavities facing the printed circuit board, After that, the inductor device is complete, and the magnetic flux is generated along the iron core when the current passes the coil.

According to the above embodiments, the manufacturing method of the inductor device passes the magnetic device through the through holes on the printed circuit boards, and the coil is wired on the printed circuit board, or between the printed circuit boards when the whole integrated circuit have multiple printed circuit boards, which reduce the volume of the whole integrated circuit. In addition, the coil wiring can be done with the PCB layout process, which simplifies the inductor manufacturing process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inductor device, comprises:
at least two printed circuit boards, wherein at least two through holes dispose on each of the printed circuit boards;
a magnetic device passing through the through holes disposed on the printed circuit board; and
a metal wire surrounding the magnetic device with an eddy shape.

2. The inductor device of claim 1, wherein the metal wire is made of copper.

3. The inductor device of claim 1, wherein the metal wire is disposed on the surface of at least one of the printed circuit boards.

4. The inductor device of claim 1, wherein the metal wire is disposed between the printed circuit boards.

5. The inductor device of claim 1, wherein the magnetic device comprises a first U-shaped iron core and a second U-shaped iron core, and the first U-shaped iron core and the second U-shaped iron core passes the through holes from different surfaces of the printed circuit board.

6. A method for manufacturing an inductor device, comprises:
estimating required inductance;
estimating the required turns of a coil according to the required inductance, the cross-section area and the length of a magnetic devices;
disposing the coil with the required turns;
drilling at least one through hole on a printed circuit board, wherein the through hole is disposed inner the coil; and
passing a first U-shaped iron corn and a second U-shaped iron corn through the through holes disposed on the printed circuit board.

7. The method of claim 6, wherein the coil is disposed on the printed circuit board by PCB layout.

8. The method of claim 6, wherein the coil is disposed between two of the printed circuit board.

9. The method of claim 6, wherein the coil is made of cooper.

10. The method of claim 6, wherein the first U-shaped iron core and the second U-shaped iron core passed through the printed circuit board from different faces of the printed circuit board.

11. The method of claim 6, wherein a first cavity of the first U-shaped iron core and a second cavity of the second U-shaped iron core face the printed circuit board.
